(19) United States
(12) Patent Application Publication
(10) Pub. No.: US 2010/0317513 A1
(43) Pub. Date: Dec. 16, 2010

(54) MAT FOR ABSORBING LIQUIDS

(76) Inventor: Anthony J. Senzamici, JR., Lakeland, FL (US)

Correspondence Address: LARSON AND LARSON, 11199 69TH STREET NORTH, LARGO, FL, 33773, US

(21) Appl. No.: 12/494,612

(22) Filed: Jun. 30, 2009

Related U.S. Application Data
(63) Continuation-in-part of application No. 12/484,688, filed on Jun. 15, 2009.

(51) Int. Cl. B01J 20/22

(52) U.S. Cl. 502/402

(57) ABSTRACT

A fluid absorption mat is applied to a floor where fluids often drip. The fluids are absorbed through an upper and/or lower layer. The upper and lower layers are less absorbent than an intermediate layer which is made of a cloth or paper integrated with copolymers. The intermediate layer absorbs and retains fluids introduced into the absorption mat making cleanup more efficient.

### CROSS-REFERENCE TO RELATED APPLICATION

This is a continuation-in-part application to U.S. patent application Ser. No. 12/484,688, filed Jun. 15, 2009, inventor Anthony J. Senzamici, the disclosure of which is herein incorporated by reference.

### FIELD OF THE INVENTION

This invention relates to floor covering and more particularly to a mat for absorbing liquids.

### BACKGROUND

Liquid absorptive polymer materials are well known in the prior art as seen in U.S. Pat. Nos. 4,295,987 and 4,865,886. In addition, it is known to incorporate these polymers between paper or diaper cloth to make absorptive materials. The aforementioned U.S. Pat. No. 4,865,886 describes polymerizing acrylic acid monomers on prefabricated fibrous substrate to form a composite of the polymer derived from the monomer and said fibrous substrate. Cross linking agents are then reacted with the polymer to form a liquid absorptive polymer.

The prior art composite materials are excellent vehicles for absorbing liquids, but are not designed to retain liquids when pressure, such as the weight of a person, is exerted on the absorbent materials.

U.S. Pat. No. 5,434,339 to La Motte, et al, describes a fluid absorption mat that has copolymer interlocked between two layers of an absorbent, non-woven fiber. This patent is hereby incorporated by reference. The fluid absorption mat described in this patent has a different intermediate layer and the patent does not disclose a non-porous, skid-resistant backing.

A self contained floor mat is needed which will absorb and retain fluids in the floor mat even when there is the pressure of a standing person and prevent leakage of the fluids during the disposal process.

### SUMMARY OF THE INVENTION

The present invention includes a fluid absorption mat. The fluids are absorbed through an upper and lower layer. The upper and lower layers are of a different material than an intermediate layer which is made of a cloth or paper integrated with copolymers absorbs and retains fluids introduced into the absorption mat. The intermediate layer is more absorbent than the upper and lower layers.

In one embodiment, an absorption mat is disclosed including a top layer made of a fluid-absorbing material and a bottom layer, also made of the fluid-absorbing material. An intermediate layer is disposed between the top layer and the bottom layer. The intermediate layer is made of a sheet of porous material integrated with polymers and is, therefore, more absorbent than the top layer and the bottom layer. An outer edge area of the top layer is bonded to an outer edge area of the bottom layer.

In another embodiment, a method of containing spilled fluids is disclosed including applying to a floor in an area onto which fluids drip, an absorption mat, the absorption mat has a top layer and a bottom layer made of a fluid-absorbing material. Between the top layer and bottom layer is an intermediate layer made of a sheet of porous material having polymers. The intermediate layer is more absorbent than either of the top layer or the bottom layer. At least an outer edge area of the top layer and an outer edge area of the bottom layer are bonded together. After absorbing fluids, the absorption mat is disposed in a waste container.

In another embodiment, an absorption mat is disclosed including a top layer and a bottom layer, both layers made of felt and an intermediate layer. The intermediate layer is made of a sheet of paper material having polymers bonded therein and is more absorbent than either of the top layer or the bottom layer. An outer edge area of the top layer and an outer edge area of the bottom layer is bonded together, thereby retaining the intermediate layer between the top layer and the bottom layer.

### BRIEF DESCRIPTION OF THE DRAWINGS

The invention can be best understood by those having ordinary skill in the art by reference to the following detailed description when considered in conjunction with the accompanying drawings in which:

FIG. 1 depicts an application of the present invention.

FIG. 1A depicts a second application of the present invention.

FIG. 1B depicts a third application of the present invention.

FIG. 2 is a top perspective view of the mat of the present invention.

FIG. 3 is a top plan view of the mat of the present invention.

FIG. 4A is a sectional view along line 4-4 of the mat of the present invention.

FIG. 4B is a sectional view along line 4-4 of the mat of the present invention.

FIG. 4C is a sectional view along line 4-4 of the mat of the present invention.

FIG. 4D is a sectional view along line 4-4 of the mat of the present invention.

FIG. 5 is a perspective view of a method of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

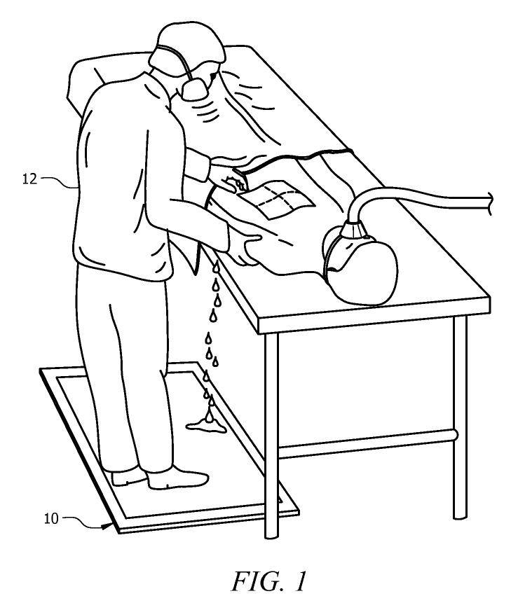

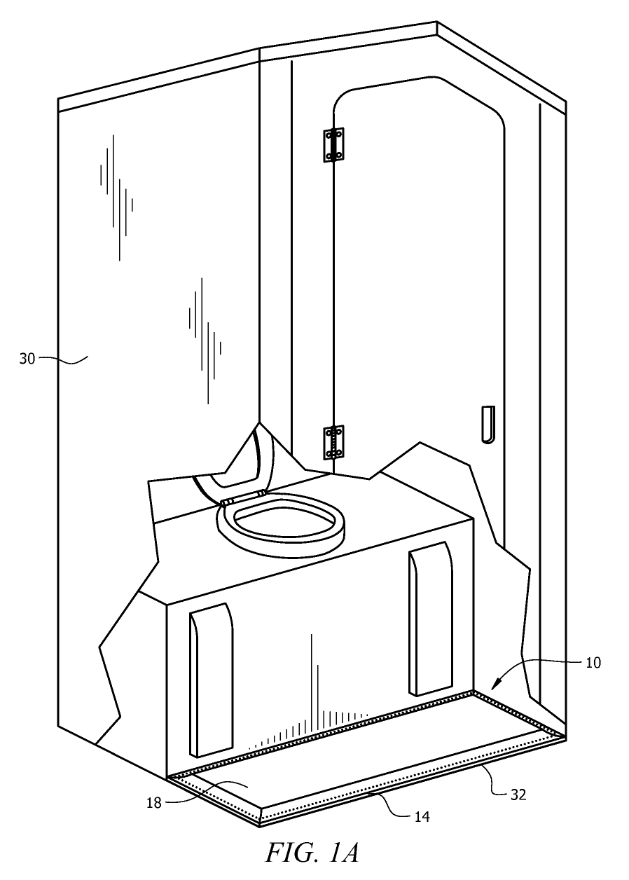

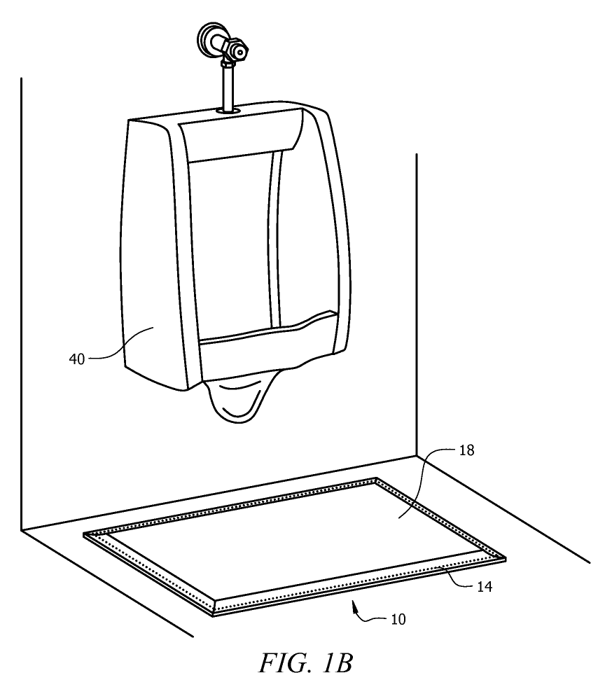

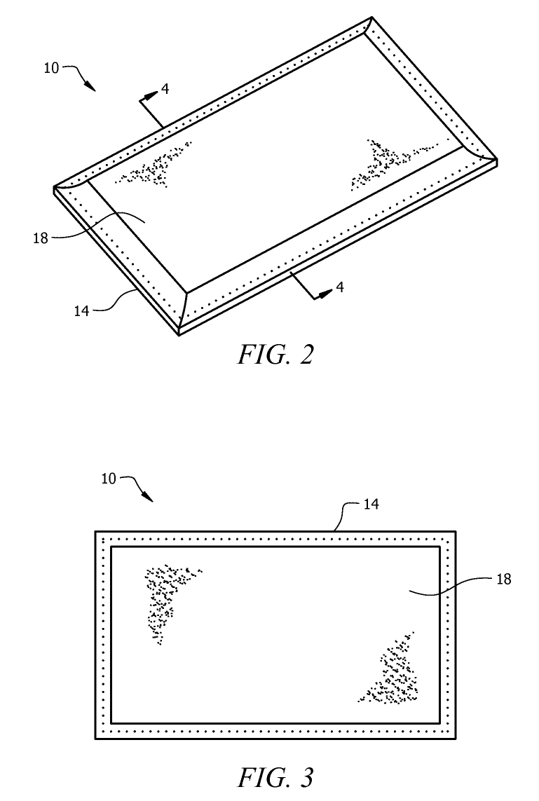

A medical example of the method and apparatus of absorbing and retaining fluids is shown in use in FIG. 1. In this example, the mat 10 is placed, for example, on a hospital room operating floor or ambulatory surgery center floor in an area where fluids drip and hospital personnel 12 stand during a medical procedure. The mat 10 has three layers, an upper layer 14, a bottom layer 16, and an intermediate layer 18, as shown in FIGS. 2, 3 and 4A-4D. The mat 10 captures and absorbs such liquids for proper disposal (see FIG. 5).

The mat 10, having at least three layers and each layer having cushioning properties, also reduces fatigue of those who stand on the mat for long periods of time, such as doctors and other medical personel.

A second example of the method and apparatus of absorbing and retaining fluids is shown in use in FIG. 1A. In this example, the mat 10 is placed on the floor of a portable toilet 30 where fluids often drip and people stand. Although shown in a generally rectangular shape, it is anticipated that in some embodiments, the mat 10 is shaped to conform to the space in which it is deployed. For example, in some embodiments, the mat 10 is U-shaped to surround an object such as a toilet bowl.

A third example of the method and apparatus of absorbing and retaining fluids is shown in use in FIG. 1B. In this example, the mat 10 is placed on the floor beneath a urinal 40 where fluids often drip and people stand. Although shown in a generally rectangular shape, it is again anticipated that in some embodiments, the mat 10 is shaped to conform to the space in which it is deployed. For example, in some embodiments, the mat 10 is U-shaped to surround an object such as a toilet bowl.

There are many uses for such a liquid absorption mat, including for applications as stated above, animal cages or enclosures, litter boxes, etc.

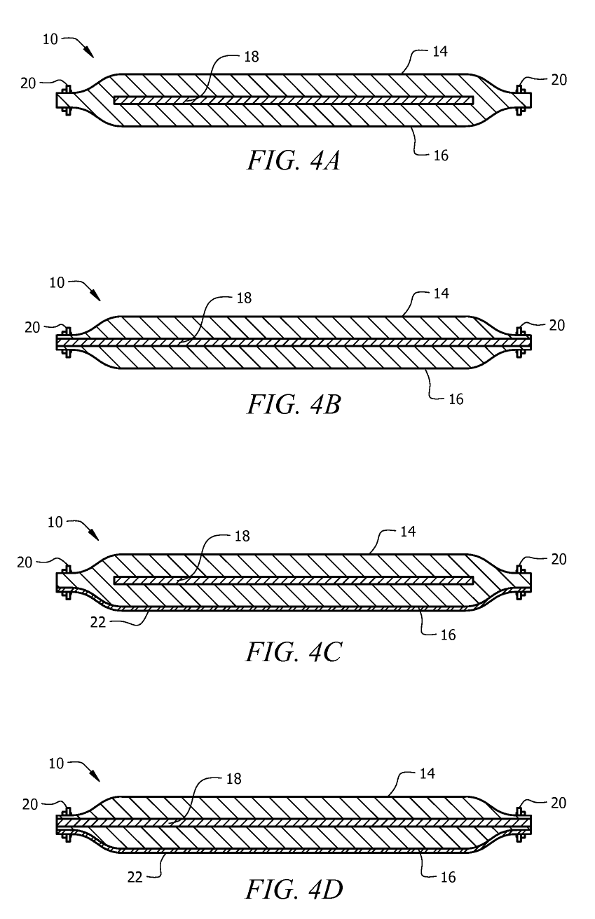

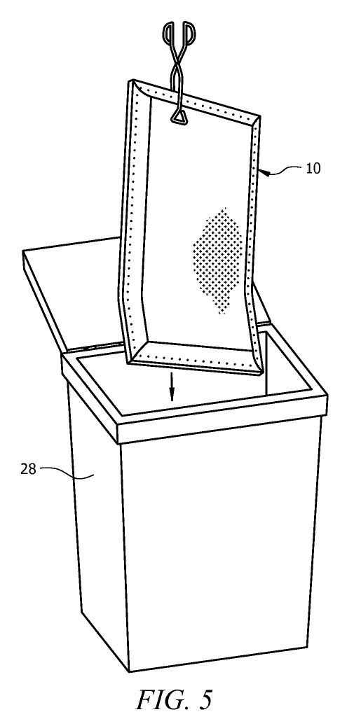

Referring to FIG. 2, a top perspective view of the mat of the present invention is shown. Although there are many ways known to assemble layers to a mat 10, the layers 14, 16 and 18 (see FIGS. 4A-D) are shown joined by needle punches or stitches. Other methods are anticipated such as the use of an adhesive, static force, melting, compression, etc, as known in the art.

Referring to FIG. 3, a top plan view of the mat of the present invention is shown. Again, in this example, the layers 14/16/18 are shown assembled using needle punches and/or stitches.

Referring to FIG. 4A, a sectional view of the mat of the present invention is shown. The upper layer 14 and the bottom layer 16 are made of a fluid absorbing material. The intermediate layer 18 is a sheet of a porous material 18 that includes polymers either internal to the structure of the porous material, external to the structure (adhered) of the porous material or both internal and external. The polymers are distributed (or impregnated) within (e.g. within the weave of the sheet of porous material 18) or on an outer surface of the sheet of porous material 18 such that the sheet of porous material 18 provides a conduit or wick connecting the individual polymers, such that, fluids entering in one area of the mat 10 are absorbed by the polymers at that location and, excess fluids migrate though the sheet of porous material 18 to nearby polymers. In some embodiments, the sheet of porous material 18 is cloth or paper. In some embodiments, the sheet of porous material 18 is air-laid cellulous. In some embodiments, the sheet of porous material 18 is woven. The intermediate layer 18 is more absorbent than the upper layer 14 and the lower layer 16.

In some embodiments, the sheet of porous material 18 has a single layer, while in other embodiments, the sheet of porous material 18 has multiple layers (such as in the art of manufacturing paper towels) and, in such, the polymers are either distributed between the layers and/or adhered to one or both outside layers and/or impregnated into the fibers of the porous material.

The intermediate layer 18, being the sheet of porous material 18 having polymers, provides several enhanced features to the mat 10. Being a sheet, the polymers remain evenly distributed across the mat 10, even during transportation and foot traffic. Since the sheet of porous material 18 is cloth-like or paper-like, liquids are absorbed at the spill site and spread through capillary action throughout the intermediate layer 18 instead of remaining at the spill site. In this embodiment, the intermediate layer 18 is not anchored and does not pass between the upper layer 14 and the bottom layer 16 at the location where the upper layer 14 and the bottom layer 16 are bonded by needle holes/stitches 20. In some embodiments, an anti-microbial material is integrated into one or all of the layers 14/16/18.

Referring to FIG. 4B, a sectional view of the mat of the present invention is shown. As in the example of FIG. 4A, the upper layer 14 and the bottom layer 16 are made of a fluid absorbing material. As in FIG. 4A, the intermediate layer 18 is made of a sheet porous material 18 integrated with polymers. The intermediate layer 18, being a sheet of porous material 18 with polymers, provides several enhanced features of the mat 10. Being a sheet, it remains evenly distributed across the mat 10, even during transportation and foot traffic. Since the sheet of porous material 18 is cloth-like or paper-like, liquids are absorbed at the spill site and spread through capillary action throughout the intermediate layer 18 instead of remaining at the spill site. In this embodiment, the intermediate layer 18 is anchored, passing between the upper layer 14 and the bottom layer 16 at the location where the upper layer 14 and the bottom layer 16 are bonded by needle holes/stitches 20. In some embodiments, an anti-microbial material is integrated into one or all of the layers 14/16/18.

Referring to FIG. 4C, a sectional view of the mat of the present invention is shown. The upper layer 14 and the bottom layer 16 are made of a fluid absorbing material. As in FIGS. 4A and 4B, the intermediate layer 18 is made of a sheet porous material 18 integrated with polymers. The intermediate layer 18, being a sheet of porous material with polymers, provides several enhanced features of the mat 10. Being a sheet, it remains evenly distributed across the mat 10, even during transportation and foot traffic. Since the intermediate layer 18 is cloth-like or paper-like, liquids are absorbed at the spill site and spread through capillary action throughout the intermediate layer 18 instead of remaining at the spill site. In this embodiment, the intermediate layer 18 is not anchored and does not pass between the upper layer 14 and the bottom layer 16 at the location where the upper layer 14 and the bottom layer 16 are bonded by needle holes/stitches 20. In some embodiments, an anti-microbial material is integrated into one or all of the layers 14/16/18. In this embodiment, a non-porous, high-friction layer 22 is applied to the outer surface of the bottom layer 16. For example, a hot liquid rubber is applied or painted on the outside surface of the bottom layer 16, forming a non-porous, non-skid backing to reduce seepage through the mat 10 and reduce the potential from the mat 10 slipping out from under the workers 12.

Referring to FIG. 4D, a sectional view of the mat of the present invention is shown. As in the example of FIG. 4C, the upper layer 14 and the bottom layer 16 are made of a fluid absorbing material such as felt. As in FIGS. 4A, 4B and 4C, the intermediate layer 18 is made of a sheet porous material integrated with polymers. The intermediate layer 18, being a sheet of porous material with polymers, provides several enhanced features of the mat 10. Being a sheet, it remains evenly distributed across the mat 10, even during transportation and foot traffic. Since the sheet of porous material 18 is cloth-like or paper-like, liquids are absorbed at the spill site and spread through capillary action throughout the intermediate layer 18 instead of remaining at the spill site. In this embodiment, the intermediate layer 18 is anchored, passing between the upper layer 14 and the bottom layer 16 at the location where the upper layer 14 and the bottom layer 16 are bonded by needle holes/stitches 20. In some embodiments, an anti-microbial material is integrated into one or all of the layers 14/16/18.

In this embodiment, a non-porous, high-friction layer 22 is applied to the outer surface of the bottom layer 16. For example, a hot liquid rubber is applied or painted on the outside surface of the bottom layer 16, forming a non-porous, non-skid backing to reduce seepage through the mat 10 and reduce the potential from the mat 10 slipping out from under the workers 12.

It is anticipated that absorption mats 10 of all embodiments are supplied either in singular form or stacked. In stacked form, janitorial personnel can quickly clean heavily used areas by removing the top absorption mat 10 from a stack of absorption mats 10, thereby removing any fluids that have dripped and exposing the next, clean absorption mat 10. In this way, for example, during an event, a series of portable toilets are cleaned by the janitorial person removing the top absorption mat 10 from each portable potty periodically during an event such as a concert, etc.

Referring to FIG. 5, a perspective view of a method of the present invention is shown. After use, the mat 10 is disposed in a container 28 or any other disposal system. Because of the mat's 10 absorbency, little or no fluids migrate or drip from the mat 10 as shown in FIG. 5. It is anticipated that in some applications, the mat 10 retains several times its own weight in fluids.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. An absorption mat comprising:
a top layer made of a fluid-absorbing material;
a bottom layer made of the fluid-absorbing material; and
an intermediate layer disposed between the top layer and the bottom layer, the intermediate layer made of a sheet of polymer;
wherein at least an outer edge area of the top layer and an outer edge area of the bottom layer is bonded together.

2. The absorption mat of claim 1, wherein at least the outer edge area of the top layer, the outer edge area of the bottom layer and an outer edge of the intermediate layer is bonded together.

3. (canceled)

4. (canceled)

5. The absorption mat of claim 1, wherein the fluid-absorbing material is felt.

6. The absorption mat of claim 1, wherein the at least an outer edge area of the top layer and an outer edge area of the bottom layer is bonded together by a needle punch.

7. The absorption mat of claim 1, wherein the at least an outer edge area of the top layer and an outer edge area of the bottom layer is bonded together by an adhesive.

8. The absorption mat of claim 1, the intermediate layer is more absorbent than either of the top layer and the bottom layer.

9. The absorption mat of claim 1, further comprising a non-porous, anti-slip coating on an outer side of the bottom layer.

10. A method of containing spilled fluids, the method comprising:
applying an absorption mat to a floor in an area onto which fluids drip, the absorption mat comprising:
a top layer made of a fluid-absorbing material;
a bottom layer made of the fluid-absorbing material;
an intermediate layer disposed between the top layer and the bottom layer, the intermediate layer made of a sheet of polymer;
wherein the intermediate layer is more absorbent than either of the top layer and the bottom layer and at least an outer edge area of the top layer and an outer edge area of the bottom layer is bonded together
disposing of the absorption mat in a waste container.

11. (canceled)

12. (canceled)

13. The method of claim 10, wherein the fluid-absorbing material is felt.

14. The method of claim 10, wherein the at least an outer edge area of the top layer and an outer edge area of the bottom layer is bonded together by a needle punch.

15. The method of claim 10, wherein the at least an outer edge area of the top layer and an outer edge area of the bottom layer is bonded together by an adhesive.

16. The method of claim 10, wherein the at least an outer edge area of the top layer and an outer edge area of the bottom layer is bonded together by stitching.

17. An absorption mat, the absorption mat comprising:
a top layer and a bottom layer, both layers made of felt; and
an intermediate layer disposed between the top layer and the bottom layer, the intermediate layer made of a sheet of polymer;
wherein the intermediate layer is more absorbent than either of the top layer and the bottom layer and at least an outer edge area of the top layer and an outer edge area of the bottom layer is bonded together, thereby retaining the intermediate layer between the top layer and the bottom layer.

18. (canceled)

19. (canceled)

20. The absorption mat of claim 17, further comprising a non-porous, anti-slip coating on an outer side of the bottom layer.
